(19) United States
(12) Patent Application Publication
(10) Pub. No.: US 2026/0049034 A1
(43) Pub. Date: Feb. 19, 2026

(54) ADDITIVE COMPOSITION FOR PLASTER AND GYPSUM MUD

(71) Applicant: Pared Solutions, LLC, Ponce (PR)

(72) Inventor: Kory Edward Ehlert, Ponce (PR)

(21) Appl. No.: 19/297,674

(22) Filed: Aug. 12, 2025

Related U.S. Application Data
(60) Provisional application No. 63/682,398, filed on Aug. 13, 2024.

(51) Int. Cl. C04B 22/00; C04B 14/22; C04B 28/14; C04B 40/00; C04B 103/00

(52) U.S. Cl. CPC C04B 22/00; C04B 14/22; C04B 28/14; C04B 40/0042; C04B 2103/0075

(57) ABSTRACT

A method of preparing an additive for plaster, gypsum mud, mortar, grout, and/or other cementitious compounds may comprise mixing wollastonite and garnet in a tumble mixer for a first predetermined time period. Glass beads may be added to the mixture of wollastonite and garnet. The wollastonite, garnet, and glass beads may continue to mix in the tumble mixer for a second predetermined time period. The first predetermined time period may be approximately 10 minutes. The second predetermined time period may be approximately 5 minutes. The additive may comprise approximately 50% garnet, 25% glass beads, and 25% wollastonite by weight. The mixed additive may be packaged in a granular form. The additive may be combined with plaster, gypsum mud, mortar, grout, and/or other cementitious compounds to enhance scratch resistance, reduce dust emission, and reduce clumping due to humidity without altering set time.

### RELATED APPLICATION

Under provisions of 35 U.S. C. § 119(e), the Applicant claims benefit of U.S. Provisional Application No. 63/682,398 filed on Aug. 13, 2024, and having inventors in common, which is incorporated herein by reference in its entirety.

It is intended that the referenced application may be applicable to the concepts and embodiments disclosed herein, even if such concepts and embodiments are disclosed in the referenced application with different limitations and configurations and described using different examples and terminology.

### FIELD OF DISCLOSURE

The present disclosure generally relates to the field of construction materials and additives. More particularly, it pertains to granular additives for enhancing the properties and performance of plaster and gypsum-based compounds used in plastering and drywall finishing applications, as well as mortar, grout and other cementitious compounds (e.g., those used in Exterior Insulation and Finish Systems (EIFS)).

### BACKGROUND

The construction industry faces challenges related to the application of plaster and gypsum mud because of increased labor costs, lack of available laborers, and other factors. These materials may be susceptible to clumping when exposed to humidity. This may lead to increased time required to mix product, inconsistent application and potential waste. Dust emission during application and sanding may pose health risks to workers, create cleanup challenges, and increase the time required to apply a product and clean up a work site following application. Extensive sanding may be required to achieve a smooth finish, potentially increasing labor costs and time. Some additives in the market may contain synthetic or potentially harmful ingredients, which may raise environmental concerns. Finished surfaces may lack sufficient scratch resistance, possibly leading to durability issues.

Conventional systems in the construction industry typically utilize plaster and gypsum mud formulations that contain basic mineral fillers or synthetic polymer additives. These systems generally employ single-component mineral additives such as silica sand, calcium carbonate, or mica as fillers to modify texture and workability. Standard formulations may include synthetic polymers like vinyl acetate copolymers or cellulose ethers to improve adhesion and workability properties. Traditional manufacturing processes for these additives involve simple blending operations without sequential mixing protocols. The application methods for conventional systems require multiple coats and extensive finishing operations to achieve desired surface quality. Existing additive systems are typically designed to address single performance parameters rather than providing comprehensive enhancement across multiple properties.

Conventional plaster systems rely on calcium sulfate hemihydrate or calcium hydroxide as primary binding agents. These systems incorporate basic fillers through direct mixing without consideration for particle size distribution optimization or component interaction. Traditional gypsum mud formulations utilize calcium sulfate dihydrate with standard mineral fillers added in uniform mixing processes. The manufacturing approach for conventional additives involves batch mixing operations without sequential component addition. Application procedures for these systems typically require primer coats, multiple finish coats, and extensive sanding between applications. Conventional additive formulations are susceptible to moisture absorption due to the hygroscopic nature of base materials and lack of humidity-resistant components.

Current market solutions for construction material enhancement focus on chemical modification rather than mineral reinforcement approaches. Existing systems may incorporate synthetic thickeners, rheology modifiers, or bonding agents to address specific performance deficiencies. Traditional approaches to dust control involve chemical suppressants or coating agents that may alter material properties. Conventional scratch resistance enhancement relies on synthetic hardening agents or surface treatments applied after curing. The standard industry practice involves separate solutions for different performance issues rather than integrated additive systems. Existing manufacturing processes for construction additives typically utilize high-shear mixing or chemical reaction processes rather than mechanical tumbling operations.

Conventional additive manufacturing processes typically employ high-energy mixing systems that may alter particle morphology and surface characteristics. These processes often involve chemical reactions or thermal treatments that can compromise the inert nature of mineral components. Standard manufacturing approaches may not optimize particle distribution or component interaction within the final additive matrix. The lack of controlled mixing sequences in conventional processes may result in non-uniform additive performance across different application conditions.

Existing quality control systems for construction additives focus primarily on chemical composition rather than physical particle characteristics or mixing uniformity. Traditional testing protocols may not adequately evaluate performance under varying humidity conditions or assess long-term durability of enhanced surfaces. Conventional systems typically lack comprehensive evaluation methods for multi-functional additive performance across different construction material types.

Current packaging and distribution systems for construction additives may not preserve the physical integrity of granular formulations during transportation and storage. Existing storage methods may expose additives to moisture or temperature variations that could affect performance characteristics. Traditional packaging approaches may not provide adequate protection against particle segregation or component separation during handling.

The economic impact of existing construction material limitations extends beyond direct material costs to include labor inefficiencies and project delays. Conventional systems may require specialized equipment or application techniques that increase overall project complexity. Existing solutions may not provide cost-effective performance enhancement across the range of construction applications where plaster and gypsum mud are utilized.

Regulatory compliance for construction additives typically focuses on chemical safety rather than comprehensive performance validation. Existing certification processes may not address the multi-functional benefits provided by advanced additive systems. Traditional regulatory frameworks may not adequately evaluate the environmental benefits of natural mineral-based additives compared to synthetic alternatives.

Market demand for construction material enhancement continues to grow as building codes become more stringent and environmental considerations gain prominence. Existing solutions may not meet the evolving requirements for sustainable construction practices or worker safety standards. The construction industry requires additive systems that can provide comprehensive performance enhancement while maintaining compatibility with existing application methods and equipment.

The technical challenges facing construction material additives extend to quality assurance and performance validation systems. Existing testing methodologies may not adequately assess the multi-functional performance characteristics required for modern construction applications. Traditional quality control protocols typically evaluate individual properties in isolation rather than comprehensive performance under real-world application conditions. This fragmented approach to performance evaluation may result in additives that meet individual specifications but fail to deliver integrated benefits during actual construction operations.

Supply chain considerations for construction additives present additional challenges in the current market environment. Existing distribution systems may not provide adequate inventory management for specialized additive products. Traditional procurement processes in the construction industry may not accommodate the lead times or storage requirements associated with advanced additive formulations. The lack of standardized performance specifications across different geographic markets may create confusion regarding product selection and application protocols.

Training and education requirements for construction personnel represent a barrier to adoption of advanced additive systems. Existing workforce development programs may not include comprehensive instruction on additive selection and application techniques. Traditional construction practices may resist changes to established procedures even when performance benefits are demonstrated. The lack of standardized training protocols for additive-enhanced construction materials may result in inconsistent application results across different projects and contractors.

Environmental impact assessment for construction additives has become increasingly complex as sustainability requirements evolve. Existing life-cycle analysis methodologies may not adequately capture the full environmental benefits of natural mineral-based additives compared to synthetic alternatives. Traditional environmental compliance frameworks may focus on immediate safety concerns rather than long-term sustainability impacts. The absence of comprehensive environmental performance metrics for construction additives may limit the ability to quantify sustainability benefits for green building certification programs.

Technical documentation and specification systems for construction additives may not provide sufficient detail for optimal performance. Existing product data sheets typically focus on basic chemical composition rather than application-specific performance characteristics. Traditional specification formats may not accommodate the multi-functional nature of advanced additive systems. The lack of standardized performance testing protocols may result in inconsistent product comparisons across different manufacturers and formulations.

Integration with existing construction equipment and application methods presents challenges for advanced additive systems. Current mixing equipment may not be optimized for granular additive incorporation. Traditional application tools may require modification to achieve optimal performance with additive-enhanced materials. The compatibility of advanced additives with existing surface preparation and finishing equipment may not be adequately evaluated during product development.

Project scheduling and workflow optimization in construction operations may not account for the benefits provided by advanced additive systems. Existing project management methodologies may not capture the time savings and efficiency improvements possible with enhanced construction materials. Traditional cost estimation models may not reflect the total economic impact of reduced labor requirements and improved material performance. The lack of comprehensive performance data for project planning purposes may limit the adoption of advanced additive technologies in construction operations.

### BRIEF OVERVIEW

This brief overview is provided to introduce a selection of concepts in a simplified form that are further described below in the Detailed Description. This brief overview is not intended to identify key features or essential features of the claimed subject matter. Nor is this brief overview intended to be used to limit the claimed subject matter's scope.

In some embodiments, a method of manufacturing an additive for plaster or gypsum mud may comprise obtaining wollastonite, garnet, and glass beads. The wollastonite and garnet may be mixed in a first mixing operation. The glass beads may be added to the mixture of wollastonite and garnet. A second mixing operation may be performed on the wollastonite, garnet, and glass beads to form a granular additive.

In other embodiments, a composition for use as an additive in plaster or gypsum mud may comprise garnet, glass beads, and wollastonite. The composition may be in a granular form.

In still further embodiments, a composition for use as an additive in plaster or gypsum mud may consist essentially of 50% garnet, 25% glass beads, and 25% wollastonite by weight. The composition may be in a granular form.

In additional embodiments, a composition for use as an additive in plaster, gypsum mud, mortar, grout and/or other cementitious compounds (e.g., those used for EIFS systems) may be produced by a process comprising mixing wollastonite and garnet in a tumble mixer for a first predetermined time period. Glass beads may be added to the mixture of wollastonite and garnet. The mixing of the wollastonite, garnet, and glass beads in the tumble mixer may continue for a second predetermined time period. The composition may be in a granular form.

Both the foregoing brief overview and the following detailed description provide examples and are explanatory only. Accordingly, the foregoing brief overview and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicant. In addition, the drawings may contain other marks owned by third parties and are being used for illustrative purposes only. All rights to various trademarks and copyrights represented herein, except those belonging to their respective owners, are vested in and the property of the Applicant. The Applicant retains and reserves all rights in its trademarks and copyrights included herein, and grants permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure. In the drawings:

FIG. 1 is a flow chart of a method for providing an additive composition for use with plaster gypsum mud, mortar, grout, and/or other cementitious compounds;

FIG. 2 is chart of a method for preparing an additive for plaster, gypsum mud, mortar, grout, and/or other cementitious compounds; and

FIG. 3 is a flow chart for a method of enhancing plaster, gypsum mud, mortar, grout, and/or other cementitious compounds.

### DETAILED DESCRIPTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure and are made merely to provide a full and enabling disclosure. The detailed disclosure herein of one or more embodiments is not intended, nor is it to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such a term to mean based on the contextual use of the term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Regarding applicability of 35 U.S. C. § 112, ¶6, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list. ”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subject matter disclosed under the header.

The construction industry faces multiple technical challenges that may significantly impact project costs, worker safety, and material performance. These challenges may encompass labor shortages, material waste, health risks from dust exposure, extensive finishing requirements, and durability concerns. The present disclosure may address these interconnected problems through a granular additive composition that may enhance plaster and gypsum mud performance across multiple application scenarios.

Labor costs may represent a substantial portion of construction project budgets, particularly in drywall finishing and plastering applications. Traditional plaster and gypsum mud formulations may require extensive sanding operations to achieve acceptable surface finishes. This sanding process may demand skilled labor and may consume significant time during project completion phases. The need for multiple coating applications and subsequent sanding cycles may compound these labor requirements. Projects involving large surface areas may experience particularly acute labor cost impacts due to the cumulative effect of these time-intensive finishing processes.

Material waste may occur when plaster, gypsum mud, mortar, grout, and/or other cementitious compound products may clump due to humidity exposure during storage and application. These clumped materials may become difficult to work with and may require disposal when they may reach unusable consistency levels. The clumping phenomenon may be particularly problematic in humid climates or during seasonal weather transitions when moisture levels may fluctuate significantly. Construction sites may experience material loss rates that may impact project budgets and scheduling. The replacement of clumped materials may require additional procurement cycles that may delay project timelines.

Dust emission during application and sanding operations may pose significant health risks to construction workers and building occupants. Airborne particulates may create respiratory hazards that may require specialized protective equipment and ventilation systems. The cleanup of dust-contaminated work areas may add substantial time to project schedules. Regulatory compliance requirements may mandate dust control measures that may increase project complexity and costs. Interior construction projects may be particularly sensitive to dust contamination due to the presence of finished surfaces and building systems that may require protection.

Surface durability may present ongoing challenges in commercial and residential applications. Traditional formulations may exhibit limited scratch resistance that may lead to premature surface damage. High-traffic areas may show wear patterns that may require frequent maintenance and refinishing. The lack of adequate scratch resistance may result in customer dissatisfaction and warranty claims. Projects requiring long-term durability may demand enhanced surface properties that may exceed the capabilities of conventional formulations.

One use case may focus on drywall finishing applications in commercial construction projects where multiple technical challenges may converge to create significant project impacts. In these scenarios, contractors may face tight scheduling constraints that may make labor efficiency critical to project success. The combination of large surface areas, quality requirements, and time constraints may create conditions where traditional materials and methods may prove inadequate. Enhanced plaster and gypsum mud formulations may provide solutions that may address multiple challenges simultaneously while maintaining compatibility with existing application techniques and equipment.

The granular additive composition may find application in Exterior Insulation and Finish Systems (EIFS) where enhanced performance characteristics may be especially beneficial for building envelope applications. EIFS systems may typically comprise multiple layers including insulation boards, base coats, reinforcing mesh, and finish coats that may require superior adhesion, durability, sheer strength, and weather resistance properties. The additive may be incorporated into the base coat and/or finish coat formulations to provide enhanced scratch resistance that may protect the underlying insulation system from mechanical damage during installation and service life. The reduced dust emission properties of the enhanced cementitious compound mixture may be particularly advantageous in EIFS applications where workers may apply materials in confined spaces or elevated positions where dust control may be critical for safety and visibility. The humidity resistance characteristics provided by the wollastonite component may help prevent clumping of base coat materials during storage and application in varying weather conditions that may be common during exterior construction projects. The glass bead component may contribute to improved workability and surface finish quality that may be essential for achieving the smooth, uniform appearance required in EIFS finish coats. The inert nature of all three additive components may ensure compatibility with the acrylic and polymer-modified cement base coats commonly used in EIFS systems without interfering with adhesion or curing properties. The enhanced sheer strength may allow for improved capabilities to adhere rock, tile, stone, and/or other product to the finish coat, if desired.

Residential renovation projects may represent another scenario where these technical problems may manifest differently but may require similar solutions. Homeowners and contractors may prioritize dust control due to the occupied nature of residential spaces. The need to minimize disruption to daily activities may make reduced sanding requirements particularly valuable. Material waste from clumping may have proportionally greater impact on smaller projects where material quantities may be more limited.

Industrial and institutional facilities may present unique challenges related to durability and maintenance requirements. These environments may demand enhanced scratch resistance due to high-traffic conditions and frequent cleaning operations. The long-term performance characteristics of wall finishes may directly impact facility maintenance costs and operational efficiency. Projects in these sectors may require materials that may provide superior performance characteristics while maintaining cost-effectiveness over extended service periods.

The granular additive composition may provide a comprehensive solution that may address multiple technical challenges simultaneously through a synergistic combination of three mineral components. The additive may comprise approximately 50% garnet, 25% wollastonite, and 25% glass beads by weight, with each component contributing specific performance characteristics that may work together to enhance plaster, gypsum mud, mortar, grout and/or other cementitious compound applications.

The garnet component may serve as the primary active ingredient that may provide enhanced scratch resistance and durability to finished surfaces. Garnet particles may possess inherent hardness characteristics that may contribute to the overall structural integrity of applied plaster, gypsum mud, mortar, grout and/or other cementitious compounds. The abrasive properties of garnet may create beneficial surface textures that may promote adhesion of subsequent coatings or finishes. The dense nature of garnet particles may contribute to dust reduction by binding smaller particles together during application and finishing operations.

The wollastonite component may address humidity-related challenges that may cause material clumping during storage and application. Wollastonite may exhibit calcium silicate properties that may provide resistance to moisture absorption and may prevent the formation of clumps that may render materials unusable. The acicular crystal structure of wollastonite may contribute to the overall mechanical properties of the enhanced mixture. The chemical inertness of wollastonite may ensure compatibility with existing plaster, gypsum mud, mortar, grout and/or other cementitious compound formulations without altering set times or chemical properties.

The glass bead component may provide flow enhancement and surface finish improvements that may reduce sanding requirements. The spherical geometry of glass beads may promote smooth application characteristics and may contribute to improved workability of the enhanced mixture. Glass beads may provide lightweight filler properties that may reduce the overall density of the final product while maintaining performance benefits. The reflective properties of glass beads may enhance the light-reflecting characteristics of finished surfaces.

The manufacturing process may utilize a two-stage tumble mixing approach that may ensure optimal component integration and granular structure formation. The first mixing stage may combine wollastonite and garnet for approximately 10 minutes, allowing these primary components to achieve thorough integration and surface interaction. The second mixing stage may incorporate glass beads for approximately 5 minutes, completing the granular structure while maintaining the integrity of the spherical glass particles.

Commercial construction projects may benefit from the additive through reduced labor costs associated with finishing operations. Large-scale drywall installations may experience significant time savings due to reduced sanding requirements and improved surface quality. The enhanced scratch resistance may provide long-term durability benefits that may reduce maintenance costs over the service life of the installation. Dust reduction capabilities may improve working conditions and may reduce cleanup time, contributing to overall project efficiency.

Residential applications may particularly benefit from the dust reduction properties of the enhanced mixture. Occupied homes undergoing renovation may experience less disruption due to reduced airborne particulates during application and finishing. The improved workability may allow contractors to achieve professional-quality results with reduced skill requirements. The natural ingredient composition may address homeowner concerns regarding indoor air quality and environmental impact.

Specialty applications may include high-traffic commercial environments where enhanced durability may provide significant value. Educational facilities, healthcare institutions, and retail spaces may require wall finishes that may withstand frequent cleaning and incidental contact. The enhanced scratch resistance may maintain appearance quality over extended periods, reducing the frequency of refinishing operations.

The additive may be incorporated into existing construction workflows without requiring equipment modifications or specialized training. Standard mixing procedures may be adapted to accommodate the granular additive, allowing for seamless integration into current practices. The inert nature of the components may ensure compatibility with various plaster, gypsum mud, mortar, grout and/or other cementitious compound formulations from different manufacturers.

Quality control measures may be implemented during manufacturing to ensure consistent performance characteristics across production batches. The specific ratios of components may be maintained through precise weighing and measurement systems. The tumble mixing process may be monitored to ensure adequate mixing times and uniform distribution of components.

Packaging and distribution considerations may include container inversion strategies that may optimize particle distribution during storage. The granular nature of the additive may allow for efficient packaging in various container sizes to accommodate different project requirements. Storage stability may be maintained through proper moisture control and temperature management during distribution.

Environmental benefits may extend beyond the use of natural ingredients to include reduced waste generation through improved material utilization. The prevention of clumping may reduce material disposal requirements, contributing to overall project sustainability. The reduced sanding requirements may decrease the generation of construction waste and may minimize the need for dust collection and disposal systems.

The present disclosure includes many aspects and features. Moreover, while many aspects and features relate to, and are described in, the context of an additive compositing for use with plaster, gypsum mud, mortar, grout and/or other cementitious compounds, embodiments of the present disclosure are not limited to use only in this context.

### I. Platform Overview

This overview is provided to introduce a selection of concepts in a simplified form that are further described below. This overview is not intended to identify key features or essential features of the claimed subject matter. Nor is this overview intended to be used to limit the claimed subject matter's scope.

The present disclosure may relate to systems, methods, and compositions for enhancing plaster, gypsum mud, mortar, grout and/or other cementitious compounds. The key operative embodiments may include a method of preparing an additive, a composition for use as an additive, and a method of enhancing plaster, gypsum mud, mortar, grout and/or other cementitious compounds.

In embodiments, the method may result in an additive that improves properties of plaster, gypsum mud, mortar, grout and/or other cementitious compounds, such as (but not limited to) reducing clumping due to humidity, lowering dust emission, increasing scratch resistance, increasing sheer strength, and allowing for less (e.g., low to no) sanding. The additive may reduce the need for a bonding agent, which is needed when using conventional drywall finishing compounds and plasterboard finishes, and may decrease the amount of time needed for the plaster, gypsum mud, mortar, grout and/or other cementitious compounds to which it is added to cure. In some embodiments, the additive may enhance adhesive properties and/or sheer strength of the plaster, gypsum mud, mortar, grout and/or other cementitious compounds to which it is added.

The additive composition may comprise approximately 50% garnet, 25% glass beads, and 25% wollastonite by weight. The ingredients may be mixed in a tumble mixer, with wollastonite and garnet mixed for a first time duration (e.g., about 10 minutes), followed by the addition of glass beads and mixing for a second time duration (e.g., about 5 minutes).

The resulting granular additive may be combined with plaster, gypsum mud, mortar, grout and/or other cementitious compounds to enhance various properties thereof. The enhanced mixture may exhibit increased scratch resistance, reduced dust emission, and/or reduced clumping due to humidity compared to compounds without the additive.

The additive may be inert and may not alter the set time of the compound when combined therewith. The composition may be configured to be added in varying amounts to achieve different levels of enhancement.

The mixing process may result in a unique shape or structure of the granular additive, which may contribute to its effectiveness when combined with plaster, gypsum mud, mortar, grout and/or other cementitious compounds.

The additive may be suitable for use in both the plaster market and the gypsum mud market, providing versatility in its applications. The composition may be packaged in granular form for distribution to end users.

Embodiments of the additive composition may comprise at least the following components:
A. Garnet;
B. Wollastonite; and
C. Glass Beads.

In some embodiments, the additive compound may not contain any additional ingredients.

The following depicts an example of a method of a plurality of methods that may be performed to form the additive composition. Although methods may be described to be performed by a single device, it should be understood that, in some embodiments, different operations may be performed by different devices.

Furthermore, although the stages of the following example method are disclosed in a particular order, it should be understood that the order is disclosed for illustrative purposes only. Stages may be combined, separated, reordered, and various intermediary stages may exist. Accordingly, it should be understood that the various stages, in various embodiments, may be performed in orders that differ from the ones disclosed below. Moreover, various stages may be added or removed without altering or departing from the fundamental scope of the depicted methods and systems disclosed herein.

The method may comprise the following stages:
adding wollastonite and garnet to a mixing apparatus;
mixing the wollastonite and the garnet in the mixing apparatus for a first predetermined time period;
adding glass beads to the mixture of wollastonite and garnet; and
mixing the wollastonite, garnet, and glass beads in the mixing device for a second predetermined time period.

Both the foregoing overview and the following detailed description provide examples and are explanatory only. Accordingly, the foregoing overview and the following detailed description should not be considered to be restrictive. Further, features or variations may be provided in addition to those set forth herein. For example, embodiments may be directed to various feature combinations and sub-combinations described in the detailed description.

### II. Additive Components

Embodiments of the present disclosure provide an additive that improves properties of plaster, gypsum mud, mortar, grout and/or other cementitious compounds. The additive may be formed from a mixture of garnet, wollastonite, and glass beads. In some embodiments, the additive compound may not contain any additional ingredients. The additive may include a mixture of components including:

### A. Garnet

In embodiments, the additive may include garnet. Garnet may form the largest portion of the additive, making up approximately 50% of the additive by weight (e.g., in the range of about 40% to about 60%). The term “garnet” may refer to any of a group of nesosilicates having the general formula X₃Y₂(ZO₄)₃. The X site may be occupied by divalent cations (e.g., Ca, Mg, Fe, Mn)²⁺. The Y site may be occupied by trivalent cations (e.g., Al³⁺, Fe³⁺, Cr³⁺). The Z site is often occupied by silicon, but may be occupied by other elements, including germanium, gallium, aluminum, vanadium and iron. In some embodiments (e.g., where silicon occupies the Z site), the cations occupying the X and Y sites may form an octahedral/tetrahedral framework with the [SiO₄]⁴⁻ anions, where the [SiO₄]⁴⁻ anions occupy the tetrahedra.

Garnets may have a crystal structure corresponding to one or more of a dodecahedral crystal habit, a trapezohedron crystal habit, and/or a hexoctahedral crystal habit. The garnet may crystallize in the cubic system, having three axes that are all of equal length and perpendicular to each other, but are never actually cubic because, despite being isometric, the {100} and {111} families of planes are depleted. Garnets do not have any cleavage planes, so when they fracture under stress, sharp, irregular (conchoidal) pieces are formed.

In some embodiments, grade garnets such as almandine (iron-aluminum silicate), pyrope (magnesium-aluminum silicate), and/or andradite (calcium-iron silicate) may be used as the garnet component of the additive. However, other garnet compositions may be used in addition to or in place of these industrial garnets without departing from the scope of the invention.

The garnet particles may exhibit hardness characteristics that may contribute to the enhanced scratch resistance properties of the finished surface when the additive may be combined with plaster, gypsum mud, mortar, grout and/or other cementitious compounds. The dense crystalline structure of garnet may provide mechanical reinforcement to the applied material during curing and service life.

The garnet component may function as an abrasive aggregate that may create beneficial surface textures during application. These surface textures may promote improved adhesion characteristics for subsequent coating layers or finishing treatments. The irregular fracture patterns typical of garnet particles may contribute to mechanical interlocking within the matrix of the compound.

The chemical inertness of garnet may ensure compatibility with various formulations of plaster, gypsum mud, mortar, grout and/or other cementitious compounds without interfering with hydration reactions or set time characteristics. The garnet particles may maintain their structural integrity throughout the mixing, application, and curing processes. The thermal stability of garnet may contribute to dimensional stability of the finished surface under varying temperature conditions.

The particle size distribution of the garnet component may be selected to optimize or otherwise improve performance characteristics within the additive mixture. Garnet particles may range from fine to medium grades depending on the specific application requirements, desired surface finish characteristics, and/or other factors. The angular geometry of fractured garnet particles may enhance the binding properties of fine particles during application and finishing operations.

The garnet component may interact with the other additive components (e.g., wollastonite and/or glass beads) during the tumble mixing process to form integrated granular structures. These interactions may occur through mechanical abrasion and surface contact that may create enhanced bonding between components. The resulting composite granules may exhibit performance characteristics that may exceed those of individual components.

Garnets may be used in various industrial applications due to their hardness, durability, and abrasive properties. In the context of the additive composition, garnet may serve multiple functions. The garnet component may contribute to the scratch resistance of the final compound mixture. The hardness of garnet particles may enhance the overall durability and toughness of the applied surface.

Garnet may also play a role in reducing dust emission during application and sanding of the compound. The dense nature of garnet particles may help to bind finer particles together, potentially decreasing the amount of airborne dust generated during handling and finishing processes.

The abrasive properties of garnet may be beneficial in creating a suitable surface texture for the plaster, gypsum mud, mortar, grout and/or other cementitious compounds. This texture may promote better adhesion of subsequent layers or finishes applied to the surface.

Garnet may contribute to the overall stability of the additive mixture. The inert nature of garnet may help to prevent unwanted chemical reactions within the additive or when combined with the compound.

The inclusion of garnet in the additive may affect the water retention properties of the compound mixture. This could potentially impact the workability and drying time of the applied material.

The specific particle size distribution of the garnet used in the additive may be selected to optimize or otherwise improve performance of the garnet in the mixture. Finer garnet particles may provide different benefits compared to coarser particles, potentially affecting properties such as workability, surface finish, and overall strength of the final product.

In some embodiments, the garnet may interact with the other components of the additive, such as wollastonite and glass beads, in ways that contribute to the unique properties of the final mixture. The combination of these materials may result in a synergistic effect that enhances the overall performance of the additive.

### B. Wollastonite

In embodiments, the additive may include wollastonite, also known as calcium silicate. Wollastonite may make up approximately 25% of the additive by weight (e.g., in the range of about 15% to about 35%). The term “wollastonite” generally refers to a calcium inosilicate mineral having the chemical formula CaSiO₃. However, in some embodiments, iron, magnesium, and/or manganese may be substituted for the calcium in at least some of the molecules. Wollastonite is resistant to chemical attack, stable at high temperatures, and improves flexural and tensile strength in composites. Wollastonite may crystallize in a triclinic crystal system, forming acicular (needle-like) or tabular crystals. The acicular crystals may have an aspect ratio (length to width ratio) of 3:1 to 20:1. Wollastonite may have a Mohs hardness of 4.5-5 and a specific gravity of 2.87-3.09.

Wollastonite may contribute to reducing clumping due to humidity when the additive is combined with plaster, gypsum mud, mortar, grout and/or other cementitious compounds. It may also play a role in lowering dust emission of the compound. The inclusion of wollastonite in the additive composition may help increase the scratch resistance of the resulting compound mixture.

The wollastonite component may be inert and may not alter the set time of the compounds when the additive is combined with those materials. The wollastonite may interact with the other additive components during the mixing process to create a unique granular structure that contributes to the effectiveness of the additive.

The calcium silicate mineral structure of wollastonite may provide resistance to humidity-induced clumping that may commonly affect plaster, gypsum mud, mortar, grout and/or other cementitious compound materials during storage and application. The acicular crystal morphology of wollastonite may contribute to the overall mechanical properties of the enhanced mixture.

The low aspect ratio crystals of wollastonite may function as reinforcing fibers within the compound matrix. These needle-like crystals may provide directional strength characteristics that may improve the overall structural integrity of applied surfaces. The interlocking nature of wollastonite crystals may contribute to crack resistance in finished surfaces.

The chemical stability of wollastonite may help to ensure long-term performance of the enhanced compound mixture. The calcium silicate composition may be compatible with the alkaline environment typically present in gypsum-based materials. The wollastonite component may maintain its structural and chemical properties throughout the service life of the applied surface.

The moisture absorption characteristics of wollastonite may be controlled through its crystal structure and surface chemistry. The wollastonite particles may resist moisture uptake that may otherwise lead to clumping and degradation of workability. This moisture resistance may extend the shelf life and storage stability of plaster, gypsum mud, mortar, grout and/or other cementitious compound products containing the additive.

The wollastonite component may undergo surface interactions with garnet particles during the first mixing stage. These interactions may create composite structures that may combine the hardness of garnet with the fibrous reinforcement characteristics of wollastonite. The resulting integrated particles may provide synergistic performance benefits when incorporated into plaster, gypsum mud, mortar, grout and/or other cementitious compounds.

### C. Glass Beads

In embodiments, the additive may include glass beads. Glass beads may make up approximately 25% of the additive by weight (e.g., in the range of about 15% to about 35%). The glass beads may serve as a relatively lightweight filler and aggregate. Glass beads may be spherical or approximately spherical particles made from glass. As nonlimiting examples, the glass beads may be formed from soda-lime glass and/or borosilicate glass. The glass beads may be relatively small, having a diameter in the range of about 10 micrometers to about 1000 micrometers, though other diameters are possible without departing from the scope of the invention. In some embodiments, the glass beads may have a specific gravity in the range of about 2.4 to 2.6.

The glass beads may be solid or hollow. Solid glass beads may provide increased density and strength to the additive mixture. Hollow glass beads may provide lightweight properties and thermal insulation benefits.

The surface of the glass beads may be smooth or textured. Textured surfaces may help to enhance bonding with other components in the additive or with the plaster, gypsum mud, mortar, grout and/or other cementitious compounds.

The glass beads may be transparent, translucent, or opaque. The color of the glass beads may vary depending on the specific formulation and manufacturing process and the desires of the user. For example, clear glass beads may be used to maintain the original color of the compound, while colored glass beads may be used to impart a tint or decorative effect.

The chemical composition of the glass beads may vary but may typically includes silica (SiO₂) as the main component. Other oxides, such as (but not limited to) sodium oxide (Na₂O), calcium oxide (CaO), and/or aluminum oxide (Al₂O₃) may also be included. The exact composition may affect properties such as hardness, chemical resistance, and melting point.

The spherical geometry of glass beads may enhance the flow characteristics and workability of the granular additive mixture when combined with plaster, gypsum mud, mortar, grout and/or other cementitious compounds. The smooth surface properties of glass beads may contribute to improved application characteristics and reduced tool drag during spreading operations.

The glass beads may function as lightweight filler particles that may reduce the overall density of the enhanced compound mixture. This density reduction may improve handling characteristics and may reduce the physical demands on applicators during installation. The reduced weight may also contribute to improved coverage rates and material efficiency.

The optical properties of glass beads may enhance the light-reflecting characteristics of finished surfaces. The spherical shape and transparent or translucent nature of glass beads may create micro-lenses that may improve surface brightness and visual appearance. These optical effects may be particularly beneficial in interior applications where light reflection may be desired.

The chemical inertness of glass beads may ensure compatibility with various compound formulations. The silicate composition of glass beads may be stable in alkaline environments and may not interfere with chemical reactions during curing. The glass beads may maintain their spherical shape and surface properties throughout the mixing and application processes.

The glass bead component may be added during the second mixing stage to preserve the integrity of the spherical particles. The controlled mixing time may ensure proper distribution of glass beads throughout the mixture while minimizing mechanical damage to the spherical geometry. The preserved spherical shape may be essential for maintaining the flow enhancement and optical properties of the final additive.

The size distribution of glass beads may be selected to optimize performance within the additive mixture. Glass beads may range from fine to medium sizes depending on the desired application characteristics and surface finish requirements. The uniform spherical shape may provide consistent performance characteristics across the size range.

Glass beads may contribute to several properties of the additive mixture. For example, the spherical shape of glass beads may enhance the flow characteristics of the granular additive mixture; the glass beads may act as a reinforcing filler, potentially improving the compressive and tensile strength of the final product; the smooth surface of glass beads may contribute to a smoother finish in the applied plaster, gypsum mud, mortar, grout and/or other cementitious compounds; the glass beads may increase the light reflectivity of the final surface, potentially enhancing brightness in certain applications; the glass beads may be chemically inert, which may help maintain the stability of the additive mixture and/or the final product; and the inclusion of glass beads may help reduce shrinkage during the drying process of the compound.

### III. Packaging and Distribution

The completed granular additive may be packaged and distributed through multiple channels to accommodate varying market requirements and application scenarios. Container materials may be selected to provide moisture protection and maintain product integrity during storage and transportation. Packaging may include appropriate labeling with application instructions and safety information. The packaging approach may be tailored to address both standalone additive sales and pre-mixed product offerings that may include the additive already integrated with plaster, gypsum mud, mortar, grout and/or other cementitious compound formulations.

For standalone additive distribution, the granular composition may be packaged in moisture-resistant containers ranging from small consumer-sized packages to bulk industrial quantities. Small packages may accommodate residential and small commercial projects where limited quantities may be required. Medium-sized containers may serve professional contractors who may require consistent supplies for ongoing projects. Large bulk packaging may address industrial manufacturing facilities that may incorporate the additive into their own plaster, gypsum mud, mortar, grout and/or other cementitious compound production processes.

The container materials may be selected to maintain product integrity during extended storage periods. Moisture barrier properties may be incorporated to prevent humidity exposure that may otherwise compromise the anti-clumping benefits of the wollastonite component. Sealed containers may preserve the granular structure and prevent contamination during transportation and storage. Container labeling may include mixing ratios, application instructions, and safety information to facilitate proper use by end users.

Container inversion strategies may be implemented during packaging operations to optimize particle distribution characteristics. Containers may be filled and then inverted to allow denser particles to settle toward the closure end. This inversion process may facilitate more uniform mixing when containers may be opened for use. The settling of heavier components toward the accessible end may reduce mixing time requirements and may improve distribution uniformity when the additive may be combined with plaster, gypsum mud, mortar, grout and/or other cementitious compounds.

Distribution networks may be established to serve both retail and commercial markets through appropriate channels. Retail distribution may include building supply stores, home improvement centers, and specialty construction material dealers. Commercial distribution may encompass direct sales to contractors, construction companies, and industrial manufacturers. Online distribution platforms may provide access to markets where traditional retail presence may be limited.

Pre-mixed product offerings may represent an alternative distribution approach where the granular additive may be combined with the compound during manufacturing processes. These pre-mixed formulations may eliminate the need for end users to measure and combine components at job sites. The pre-mixed approach may ensure consistent additive ratios and may reduce application variability that may occur with field mixing.

Pre-mixed plaster formulations may incorporate the granular additive at predetermined ratios that may optimize performance characteristics for specific applications. Residential plaster products may include additive concentrations that may emphasize dust reduction and smooth finish properties. Commercial plaster formulations may incorporate higher additive concentrations that may prioritize scratch resistance and durability characteristics. Specialty plaster products may be formulated with customized additive ratios to address specific performance requirements.

Pre-mixed gypsum mud products may similarly incorporate the granular additive at ratios that may enhance drywall finishing applications. Ready-to-use gypsum mud formulations may include the additive in aqueous slurries that may be applied directly without additional mixing. Dry powder gypsum mud products may include the additive in formulations that may require only water addition for activation. These pre-mixed approaches may streamline application processes and may reduce the potential for mixing errors.

The pre-mixed product may be utilized in conjunction with Exterior Insulation and Finish Systems (EIFS) where the enhanced cementitious compound mixture may provide superior performance characteristics for building envelope applications. EIFS installations may require base coat and finish coat materials that may exhibit enhanced adhesion properties, improved weather resistance, and increased durability under varying environmental conditions. The pre-mixed formulation may eliminate field mixing variability and may ensure consistent additive distribution throughout the base coat application. The enhanced scratch resistance provided by the garnet component may protect the underlying insulation board from mechanical damage during installation and throughout the service life of the system. The reduced dust emission characteristics may be particularly beneficial in EIFS applications where workers may operate in elevated positions or confined spaces where dust control may be essential for safety and visibility. The wollastonite component may contribute to improved humidity resistance that may prevent base coat degradation during extended exposure periods common in exterior construction environments. The glass bead component may enhance the workability of base coat materials and may contribute to improved surface finish quality that may be required for subsequent mesh embedding and finish coat applications. The pre-mixed product may also find application with grout and mortar systems where the enhanced properties may provide improved performance in tile installation and masonry applications. The additive-enhanced grout may exhibit increased scratch resistance that may maintain surface integrity in high-traffic areas and may resist damage from cleaning operations and mechanical wear. The reduced dust emission properties may improve working conditions during grout application and cleanup operations, particularly in interior spaces where dust control may be required for occupant comfort and air quality maintenance. The humidity resistance characteristics may prevent grout clumping during storage and may maintain workability during application in varying environmental conditions. The enhanced mortar formulations may benefit from improved adhesion properties and increased durability that may be provided by the synergistic combination of garnet, wollastonite, and glass bead components.

Manufacturing facilities producing pre-mixed products may implement quality control measures to ensure consistent additive distribution throughout production batches. Mixing equipment may be calibrated to achieve uniform dispersion of the granular additive within compound matrices. Batch testing may verify additive concentration levels and may confirm performance characteristics of finished products.

Storage and handling procedures for pre-mixed products may account for the presence of the granular additive and its effects on material properties. Temperature control may be maintained to preserve the integrity of both the additive components and the base compound materials. Humidity management may prevent moisture-related degradation that may compromise the anti-clumping benefits provided by the wollastonite component.

Distribution logistics may be coordinated to maintain product quality during transportation from manufacturing facilities to end users. Shipping containers may provide protection from environmental conditions that may affect product performance. Delivery schedules may be managed to minimize storage time and may ensure product freshness at the point of use.

Market segmentation strategies may address different user categories and their specific requirements for additive packaging and distribution. Professional contractors may prefer bulk packaging options that may provide cost efficiency for large projects. DIY consumers may favor smaller packages with detailed application instructions and safety information. Industrial users may require customized packaging solutions that may integrate with their existing material handling systems.

Technical support services may accompany both standalone and pre-mixed product offerings to assist users with proper application techniques and troubleshooting. Application guidelines may be provided to help users achieve optimal results with enhanced plaster, gypsum mud, mortar, grout and/or other cementitious compound formulations. Training programs may be offered to professional contractors to familiarize them with the benefits and proper use of additive-enhanced products.

### IV. Platform Operation

Although the stages of various methods may be shown and described as being in a sequence or temporal order, the stages of any such processes or methods are not limited to being carried out in any particular sequence or order, absent an indication otherwise. Indeed, the stages in such processes or methods generally may be carried out in various different sequences and orders while still falling within the scope of the present invention. Accordingly, it is intended that the scope of patent protection is to be defined by the issued claims rather than the description set forth herein. Moreover, various stages may be added or removed without altering or departing from the fundamental scope of the depicted methods and systems disclosed herein.

The methods described herein may be performed by a single entity or may be distributed among multiple entities. In various embodiments, different operations may be performed by different devices or systems. The methods may be performed by human operators, automated equipment, or combinations thereof. The sequence of operations may be modified to accommodate different manufacturing environments, equipment capabilities, or production requirements.

Furthermore, the methods may be scaled for different production volumes, from small batch operations to large-scale industrial manufacturing. The timing of various stages may be adjusted based on equipment specifications, material properties, or desired product characteristics. Intermediate stages may be inserted between the described stages to accommodate quality control procedures, material handling requirements, or process optimization.

The methods may be performed continuously or in batch mode depending on production requirements and equipment design. Multiple batches may be processed simultaneously using parallel equipment configurations. The methods may incorporate feedback loops or iterative processes to ensure consistent product quality across production runs.

Various monitoring and control systems may be integrated into the methods to ensure proper execution of each stage. Automated systems may be employed to control timing, mixing parameters, and material handling operations. Manual oversight may be maintained to ensure quality standards and to address any process variations that may occur during execution.

Embodiments of the present disclosure provide a set of methods configured to create the aforementioned additive. The following depicts an example of at least one method of a plurality of methods that may be performed. Various hardware components may be used at the various stages of operations disclosed to form the additive.

Furthermore, although the stages of the following example method are disclosed in a particular order, it should be understood that the order is disclosed for illustrative purposes only. Stages may be combined, separated, reordered, and various intermediary stages may exist. Accordingly, it should be understood that the various stages, in various embodiments, may be performed in arrangements that differ from the ones described below. Moreover, various stages may be added or removed from the without altering or departing from the fundamental scope of the depicted methods and systems disclosed herein.

The manufacturing process may utilize a two-stage tumble mixing approach that may ensure optimal integration of the three mineral components. The tumble mixer may provide controlled mechanical action that may promote uniform distribution and surface interaction between components. The mixing vessel may be designed to accommodate dry granular materials and may provide adequate volume for thorough component integration.

### 1. First Mixing Stage

The first mixing stage may involve combining wollastonite and garnet components in the tumble mixer for approximately 10 minutes. The wollastonite and garnet may be added in a weight ratio of approximately 1:2, corresponding to 25% wollastonite and 50% garnet of the final additive composition. The tumble mixing action may create mechanical contact between the wollastonite and garnet particles.

During the first mixing stage, the acicular wollastonite crystals may interact with the angular garnet particles through abrasion and surface contact. These interactions may create composite granular structures that may combine the properties of both components. The mixing duration may be sufficient to achieve thorough integration while avoiding excessive particle size reduction.

The tumble mixing motion may provide gentle but effective mechanical action that may promote uniform distribution of components throughout the mixing vessel. The rotational speed and mixing duration may be controlled to optimize particle interaction without causing excessive wear or dust generation. The first mixing stage may establish the foundation granular structure for the final additive composition.

### 2. Second Mixing Stage

The second mixing stage may involve adding glass beads to the wollastonite and garnet mixture and continuing tumble mixing for approximately 5 minutes. The glass beads may comprise 25% of the final additive composition by weight. The shorter mixing duration may preserve the spherical geometry of glass beads while ensuring adequate distribution throughout the mixture.

The addition of glass beads during the second mixing stage may complete the three-component granular structure of the additive. The spherical glass particles may integrate with the composite wollastonite-garnet structures formed during the first mixing stage. The controlled mixing time may prevent mechanical damage to the glass beads while achieving uniform distribution.

The second mixing stage may create the final granular additive composition with optimized performance characteristics. The completed mixture may exhibit uniform distribution of all three components with maintained particle integrity. The granular structure may be suitable for packaging and distribution to end users.

### 3. Quality Control

Quality control measures may be implemented throughout the manufacturing process to ensure consistent performance characteristics. The component ratios may be verified through precise weighing and measurement systems before mixing. The mixing times may be monitored to ensure adherence to specified durations for each stage.

The completed additive may be evaluated for granular consistency and component distribution. Visual inspection may verify uniform color and texture throughout the mixture. Particle size analysis may confirm that component integrity may be maintained during the mixing process.

Batch-to-batch consistency may be monitored through standardized testing procedures. Performance characteristics may be verified through application testing with standard plaster, gypsum mud, mortar, grout and/or other cementitious compound formulations. Quality documentation may be maintained for traceability and process improvement purposes.

A. Method of Forming an Additive Composition for Use With Plaster, Gypsum Mud, Mortar, Grout and/or Other Cementitious Compounds

Consistent with embodiments of the present disclosure, a method may be performed by at least one of the aforementioned modules. The method may comprise the following stages:

First, wollastonite and garnet may be added to a mixer, such as a tumble mixer. These ingredients may be mixed together in the mixer for a first predetermined time period. As an example, the first mixing period may be approximately 10 minutes in duration.

After the first mixing period, glass beads may be added to the mixture of wollastonite and garnet in the mixer. The mixer may then continue to mix all three ingredients—wollastonite, garnet, and glass beads—for a second predetermined time period. This second mixing period may be approximately 5 minutes in duration.

The mixing process may result in a granular additive composition. The additive composition may comprise approximately 50% garnet, 25% glass beads, and 25% wollastonite by weight. In some embodiments, the additive composition may be limited to only garnet, wollastonite, and glass beads. The wollastonite and garnet may be mixed in a ratio of approximately 1:2 during the first mixing period.

The mixing process may cause the ingredients to interact and adhere together in a particular manner. This mixing process may result in a unique granular structure of the additive that may contribute to its effectiveness when combined with plaster, gypsum mud, mortar, grout and/or other cementitious compounds.

The resulting granular additive may be packaged in this form for distribution to end users. End users may then combine the granular additive with various compounds prior to application.

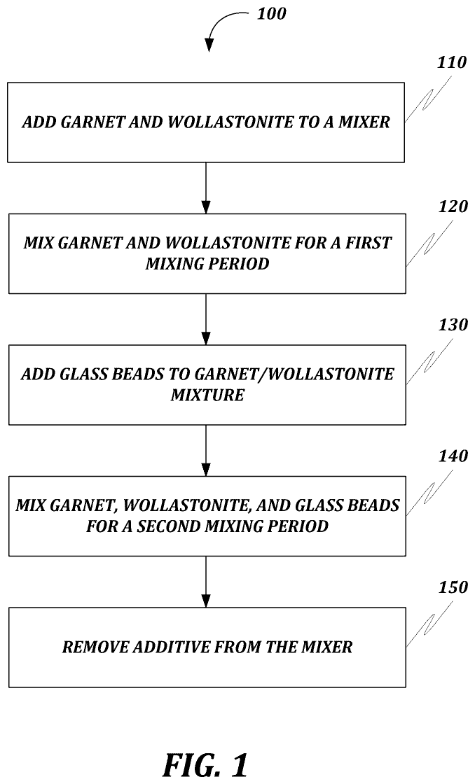

FIG. 1 is a flow chart setting forth the general stages involved in a method 100 consistent with an embodiment of the disclosure for forming the additive. Method 100 may be implemented using a mixer, such as (but not limited to) a tumble mixer, and/or any other component useful in mixing the components to form the additive.

Method 100 may begin at stage 110 where garnet and wollastonite may be added to a mixer. In embodiments, the garnet and wollastonite may be added in an approximately 2:1 ratio, by weight. That is, the weight of the added garnet may be approximately twice that of the added wollastonite.

In embodiments, the mixer may be a tumble mixer. Alternatively, the mixer may be any other mixing device configured to mix and incorporate dry components.

From stage 110, where the garnet and wollastonite are added to the mixer, method 100 may advance to stage 120 where the garnet and the wollastonite may be mixed.

A first mixing process may comprise tumbling the garnet and wollastonite in a tumble mixer for a first predetermined mixing period. As an example, the first mixing period may be approximately 10 minutes, though longer or shorter times are contemplated. The first mixing period may be any time sufficient to mix and incorporate the garnet and wollastonite. The garnet and wollastonite may abrade one another somewhat during the first mixing process.

Once the first mixing period has elapsed in stage 120, method 100 may continue to stage 130 where glass beads may be added to the mixture of garnet and wollastonite in the mixer. In embodiment, the weight of the added glass bead may be approximately equal to the weight of the wollastonite. Thus, the mixture may be 50% garnet, 25% wollastonite, and 25% glass bead, by weight.

After adding the glass in stage 130, method 100 may proceed to stage 140 where the glass beads may be mixed with the garnet and the wollastonite. For example, a second mixing process may comprise tumbling the glass beads with the garnet and wollastonite in a tumble mixer for a second predetermined mixing period. As an example, the second mixing period may be approximately 5 minutes, though longer or shorter times are contemplated. The second mixing period may be any time sufficient to mix and incorporate the glass beads with the garnet and wollastonite mixture.

The resultant mixture may be granular in nature, and may be used as an additive for enhancing various properties of plaster, gypsum mud, mortar, grout and/or other cementitious compounds to which the mixture is added.

Once the second mixing process is complete, the finished granular additive may be removed from the mixer at stage 150. In some embodiments, the additive may be mixed in relatively small quantities, and be prepared for use on a specific job. The additive may be removed from the mixer and added to plaster, gypsum mud, mortar, grout and/or other cementitious compounds to improve one or more properties thereof. In other embodiments, the additive may be mixed in large batches. In such embodiments, stage 150 may further include packaging (e.g., bagging, boxing, or otherwise containerizing) the additive for distribution to end-users, either directly or through a retail supply chain. In some embodiments, the produced additive may be combined with plaster, gypsum mud, mortar, grout and/or other cementitious compounds to form enhanced compounds. In embodiments, the compounds may be pre-mixed with water to form an aqueous slurry that is ready for application. Alternatively, the compounds may be dried (e.g., powdered) and ready to be mixed with water by an end user. The enhanced compounds may then be packaged for distribution to end users.

In some embodiments, following packaging, the containers may be inverted prior to being palletized for storage and/or distribution, such that the containers are stored upside down (e.g., with the container lid at the bottom of the container). The inversion allows heavier particles to settle downward, towards the container lid. Thereafter, an end user may re-invert the container for use, such that the container lid is at the top of the container. In this way, heavier particles disposed at the top of the container may be more readily mixed into the contents, allowing for a reduced mixing time to achieve even distribution of the granules and/or the compound mixed therewith.

In some embodiments, the combined additive and the compound mixed therewith may be applied to a surface. The enhanced mixture may exhibit increased scratch resistance, increased sheer force, reduced dust emission, and/or reduced clumping due to humidity compared to plaster or gypsum mud without the additive.

B. Method of Preparing an Additive for Plaster, Gypsum Mud, Mortar, Grout and/or Other Cementitious Compounds

Consistent with embodiments of the present disclosure, a method may be performed by at least one of the aforementioned modules. The method may comprise the following stages:

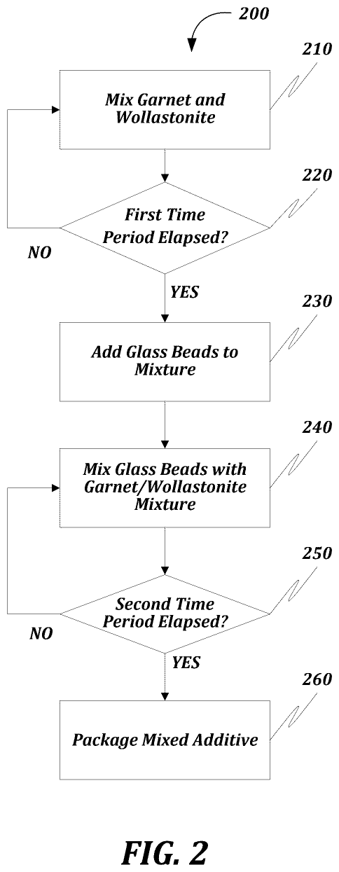

FIG. 2 illustrates a detailed method 200 for preparing the granular additive composition through a controlled mixing process with time-based monitoring stages. The method 200 may begin at stage 210 where garnet and wollastonite components may be mixed in the tumble mixer according to the predetermined weight ratios. The mixing apparatus may receive the garnet component comprising approximately 50% of the final additive composition and the wollastonite component comprising approximately 25% of the final additive composition.

The tumble mixing operation at stage 210 may create mechanical interaction between the garnet and wollastonite particles through controlled rotational motion. The garnet particles may undergo surface contact with the acicular wollastonite crystals during this mixing phase. The tumble mixer may provide consistent mechanical action that may promote uniform distribution of both components throughout the mixing chamber.

Stage 220 may involve monitoring the elapsed time of the first mixing period to determine when the predetermined duration may be reached. The first time period may be approximately 10 minutes, though this duration may be adjusted based on batch size, mixing speed, or desired integration characteristics. During this monitoring stage, the mixing process may continue until the predetermined time threshold may be satisfied.

When the first time period may not be elapsed, the method 200 may return to stage 210 where mixing of garnet and wollastonite may continue. This feedback loop may ensure that the first mixing stage may be completed according to the specified time requirements. The continuous mixing may allow for thorough integration of the garnet and wollastonite components before proceeding to the second mixing stage.

Once the first time period may be elapsed, the method 200 may advance to stage 230 where glass beads may be added to the existing mixture of garnet and wollastonite. The glass beads may comprise approximately 25% of the final additive composition by weight. The addition of glass beads may be performed while the tumble mixer may be in operation or may be temporarily stopped to facilitate component addition.

The glass bead component may be introduced to the mixture in a controlled manner to ensure uniform distribution throughout the existing garnet-wollastonite matrix. The spherical geometry of glass beads may be preserved during this addition stage to maintain the flow enhancement properties that may be provided by the spherical particles. The glass beads may integrate with the composite structures formed during the first mixing stage.

Stage 240 may involve mixing the glass beads with the garnet and wollastonite mixture through continued tumble mixing operations. The three-component mixture may undergo mechanical blending that may create the final granular structure of the additive composition. The glass beads may be distributed throughout the mixture while maintaining their spherical integrity.

The mixing action at stage 240 may be controlled to prevent excessive mechanical damage to the glass beads while ensuring adequate integration with the existing garnet-wollastonite matrix. The tumble mixing may provide gentle but effective mechanical action that may promote uniform component distribution. The spherical glass beads may enhance the flow characteristics of the mixture during this stage.

Stage 250 may monitor the elapsed time of the second mixing period to determine when the predetermined duration for the complete mixing process may be reached. The second time period may be approximately 5 minutes, which may be sufficient to achieve uniform distribution of glass beads without compromising their spherical geometry. The shorter duration of the second mixing period may reflect the need to preserve glass bead integrity.

When the second time period may not be elapsed, the method 200 may return to stage 240 where mixing of all three components may continue. This monitoring loop may ensure that the final mixing stage may be completed according to the specified time requirements. The continued mixing may achieve the desired granular structure and component integration.

Upon completion of the second time period, the method 200 may proceed to stage 260 where the mixed additive may be packaged for storage and distribution. The completed granular additive may exhibit uniform distribution of all three components with maintained particle integrity. The packaging stage may involve transferring the additive to appropriate containers that may preserve the granular structure and prevent moisture absorption.

An example embodiment of stage 210 may involve loading a tumble mixer with 500 grams of garnet and 250 grams of wollastonite for a batch producing 1000 grams of final additive. The tumble mixer may operate at a rotational speed of approximately 30 revolutions per minute to provide adequate mixing action without excessive particle attrition. The mixing chamber may be maintained at ambient temperature and humidity conditions to prevent moisture-related issues.

An example embodiment of stage 220 may utilize a timer system that may monitor the mixing duration and may provide alerts when the first predetermined time period may approach completion. The timing system may be integrated with the tumble mixer controls to ensure consistent processing across multiple batches. Quality control personnel may verify that the garnet and wollastonite components may achieve adequate integration before proceeding to the next stage.

An example embodiment of stage 230 may involve adding 250 grams of glass beads to the existing garnet-wollastonite mixture through a controlled feeding mechanism. The glass beads may be introduced gradually over a period of 30 seconds to ensure uniform distribution throughout the mixing chamber. The glass bead addition may be performed while the tumble mixer may be operating at reduced speed to minimize particle impact.

An example embodiment of stage 240 may continue tumble mixing at the same rotational speed used in the first mixing stage while monitoring the integration of glass beads throughout the mixture. Visual inspection through observation ports may verify that glass beads may be uniformly distributed and may maintain their spherical geometry. The mixing action may be sufficient to create composite granular structures without excessive particle breakdown.

An example embodiment of stage 250 may employ the same timing system used in stage 220 to monitor the second mixing period duration. The shorter time period may reflect the reduced mixing requirements for glass bead integration compared to the initial garnet-wollastonite mixing. Process operators may verify that the final mixture may exhibit uniform color and texture before proceeding to packaging.

An example embodiment of stage 260 may involve transferring the completed additive to moisture-resistant containers that may preserve the granular structure during storage and transportation. The containers may be filled to appropriate levels to prevent excessive settling while allowing for thermal expansion. Container inversion strategies may be implemented to optimize particle distribution for end-user applications.

C. Method of Enhancing Plaster, Gypsum Mud, Mortar, Grout, and/or Other Cementitious Compounds

Consistent with embodiments of the present disclosure, a method may be performed by at least one of the aforementioned modules. The method may comprise the following stages:

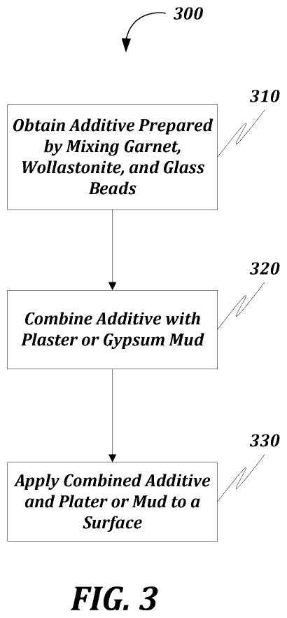

FIG. 3 illustrates a method 300 for utilizing the granular additive composition in plaster, gypsum mud, mortar, grout, and/or other cementitious compound applications. The method 300 may begin at stage 310 where an additive prepared by mixing garnet, wollastonite, and glass beads may be obtained. The additive may be in granular form and may comprise approximately 50% garnet, 25% wollastonite, and 25% glass beads by weight. The granular additive may be obtained from packaging containers that may have been previously inverted during storage to optimize particle distribution.

An example embodiment of stage 310 may involve a contractor obtaining packaged granular additive from a construction supply retailer. The contractor may verify that the container contains the proper granular consistency and uniform distribution of components. The additive may be inspected for any signs of moisture absorption or clumping that may have occurred during storage or transportation. The container may be re-inverted if necessary to ensure optimal particle distribution before use.

The method 300 may proceed to stage 320 where the additive may be combined with plaster, gypsum mud, mortar, grout, and/or other cementitious compounds to create an enhanced mixture. The additive may be incorporated into the compound through mechanical mixing to achieve uniform distribution throughout the base material. The combining process may maintain the granular structure of the additive while ensuring adequate integration with the compound matrix.

An example embodiment of stage 320 may involve adding the granular additive to dry plaster, gypsum mud powder, mortar, grout, and/or other cementitious compound powders before water addition. The additive may be distributed throughout the dry mixture using standard mixing equipment or manual stirring techniques. The ratio of additive to base material may be adjusted based on the desired level of enhancement and specific application requirements. The mixing process may continue until visual inspection confirms uniform distribution of the granular additive throughout the mixture.

Another example embodiment of stage 320 may involve combining the additive with pre-mixed plaster, gypsum mud, mortar, grout, and/or other cementitious compounds that may already contain water. The granular additive may be gradually incorporated into the wet mixture while maintaining continuous mixing action. The enhanced mixture may exhibit improved workability characteristics during the combining process. The final consistency may be adjusted through additional water or dry material as needed to achieve desired application properties.

The method 300 may advance to stage 330 where the enhanced mixture (e.g., the combined additive and compound) may be applied to a surface. The enhanced mixture may be applied using standard construction techniques and equipment without requiring modifications to existing application procedures. The application process may benefit from improved workability and reduced dust emission compared to conventional plaster or gypsum mud applications.

An example embodiment of stage 330 may involve applying the enhanced mixture to drywall surfaces using standard taping knives and application tools. The enhanced mixture may spread more smoothly due to the flow enhancement properties provided by the glass bead component. The application process may generate less airborne dust due to the particle binding effects of the garnet component. The applied surface may exhibit improved adhesion characteristics during the application process.

Another example embodiment of stage 330 may involve applying the enhanced mixture to interior wall surfaces in residential or commercial construction projects. The application may proceed at normal rates while providing superior surface finish characteristics. The enhanced mixture may maintain workability for extended periods due to the humidity resistance provided by the wollastonite component. The applied surface may require reduced finishing operations due to the improved surface properties.

The applied enhanced mixture may undergo normal curing processes without altered set times compared to conventional compounds. The curing process may result in a finished surface with enhanced scratch resistance due to the hardness characteristics of the garnet component. The finished surface may exhibit reduced susceptibility to humidity-induced degradation due to the moisture resistance properties of the wollastonite component.

A further example embodiment of stage 330 may involve applying the enhanced mixture in high-traffic commercial environments where durability may be particularly important. The enhanced mixture may be applied to wall surfaces that may experience frequent contact or cleaning operations. The application process may benefit from the reduced sanding requirements that may result from the improved surface finish characteristics. The finished surface may provide long-term performance benefits that may reduce maintenance requirements over the service life of the installation.

The enhanced mixture may maintain chemical compatibility with various plaster, gypsum mud, mortar, grout and/or other cementitious compound formulations from different manufacturers. The inert nature of the additive components may help to ensure that no unwanted chemical reactions may occur during application or curing. The enhanced mixture may be suitable for use in both interior and exterior applications depending on the base material specifications and environmental conditions.

### V. Aspects

The following discloses various Aspects of the present disclosure. The various Aspects are not to be construed as patent claims unless the language of the Aspect appears as a patent claim. The Aspects describe various non-limiting embodiments of the present disclosure.

The particle size distribution characteristics of each component may be selected to optimize performance within the enhanced plaster, gypsum mud, mortar, grout, and/or other cementitious compound matrix. Fine particle sizes may provide different performance benefits compared to coarser particles, with each size range contributing specific properties to the final mixture. The particle size selection may affect workability characteristics, surface finish quality, and overall mechanical properties of the applied surface.

The manufacturing process may incorporate quality control measures to verify particle size distributions and component purity levels. Raw material specifications may be maintained to ensure consistent performance characteristics across production batches. Component sourcing may be managed to provide reliable supply chains for the three mineral ingredients.

The granular additive may be produced in various batch sizes to accommodate different market requirements. Small batch production may serve specialty applications or testing purposes. Large batch production may provide economies of scale for commercial distribution and manufacturing efficiency.

Storage stability of the completed granular additive may be maintained through proper moisture control and container selection. The additive may resist degradation during extended storage periods due to the inert nature of the mineral components. Temperature variations during storage may not significantly affect the performance characteristics of the granular mixture.

The additive may be compatible with various compound formulations from different manufacturers. The inert mineral composition may help to ensure that no adverse chemical reactions may occur when combined with different base materials. The additive may maintain its performance benefits across a range of application conditions and environmental factors.

Application equipment compatibility may be maintained through the granular structure and flow characteristics of the additive. Standard mixing equipment may be used to incorporate the additive into plaster, gypsum mud, mortar, grout, and/or other cementitious compounds without requiring specialized machinery. The additive may not interfere with pumping systems or spray application equipment commonly used in construction applications.

The environmental impact of the additive may be minimized through the use of naturally occurring mineral components. The garnet, wollastonite, and glass bead components may be sourced from established mining and manufacturing operations with minimal environmental disruption. The additive may contribute to reduced construction waste through improved material utilization and reduced sanding requirements.

Worker safety benefits may extend beyond dust reduction to include improved working conditions and reduced exposure to chemical additives. The natural mineral composition may eliminate concerns about synthetic chemical exposure during application. The reduced sanding requirements may decrease the need for respiratory protection equipment and dust collection systems.

The economic benefits of the additive may include reduced labor costs, decreased material waste, and improved project efficiency. The enhanced performance characteristics may provide long-term value through reduced maintenance requirements and improved surface durability. The additive may contribute to overall project cost reduction through multiple performance improvements.

Market applications may extend beyond traditional construction uses to include specialty applications where enhanced surface properties may be beneficial. Industrial facilities, healthcare environments, and educational institutions may benefit from the improved durability and reduced maintenance characteristics. The additive may be suitable for both new construction and renovation projects where performance enhancements may be particularly valuable.

The technology may be scalable for different production volumes and market requirements. Manufacturing processes may be adapted to accommodate varying demand levels while maintaining consistent product quality. The additive formulation may be modified within the disclosed ranges to address specific application requirements or regional preferences.

Future development opportunities may include optimization of particle size distributions, exploration of alternative mineral sources, and development of specialized formulations for specific applications. The fundamental three-component approach may serve as a platform for additional product variations while maintaining the core performance benefits of the disclosed invention.

The synergistic effects of the three-component mixture may result from the specific interactions between garnet, wollastonite, and glass beads during the mixing process and subsequent application. These interactions may create performance characteristics that may exceed the sum of individual component benefits. The granular structure formed during tumble mixing may be essential for achieving the desired performance enhancements when the additive may be combined with plaster, gypsum mud, mortar, grout and/or other cementitious compounds.

The technical advantages provided by the granular additive composition may be understood through examination of the specific performance enhancements achieved by each component and their synergistic interactions. The garnet component may provide mechanical reinforcement through its inherent hardness characteristics that may range from 6.5 to 7.5 on the Mohs scale. This hardness may translate directly to enhanced scratch resistance in finished surfaces by creating a reinforced matrix within the compound structure. The angular fracture patterns of garnet particles may create mechanical interlocking mechanisms that may distribute stress loads across the surface, thereby reducing susceptibility to localized damage from impact or abrasion.

The wollastonite component may address humidity-related performance issues through its calcium silicate crystal structure that may exhibit low moisture absorption characteristics. The acicular morphology of wollastonite crystals may create a three-dimensional reinforcement network within the compound matrix. This needle-like structure may provide directional strength enhancement while simultaneously creating barriers to moisture migration that may otherwise lead to clumping and material degradation. The aspect ratio of wollastonite crystals, typically ranging from 3:1 to 20:1, may optimize the balance between reinforcement effectiveness and workability preservation.

The glass bead component may contribute to performance enhancement through its spherical geometry that may function as microscopic ball bearings within the mixture. This spherical morphology may reduce internal friction during application, thereby improving workability and reducing tool drag. The smooth surface characteristics of glass beads may promote laminar flow patterns during application that may minimize air entrainment and surface irregularities. The optical properties of glass beads may enhance light reflectance characteristics of finished surfaces through their refractive index properties that may approach those of common glass formulations.

The two-stage mixing process may create composite granular structures that may exceed the performance characteristics of individual components. During the first mixing stage, the abrasive action between garnet and wollastonite particles may create surface texturing that may enhance mechanical bonding between components. The garnet particles may abrade the wollastonite crystals, creating fresh surface areas with increased reactivity and bonding potential. This mechanical interaction may result in composite particles that may combine the hardness of garnet with the fibrous reinforcement characteristics of wollastonite.

The addition of glass beads during the second mixing stage may preserve their spherical integrity while allowing integration with the composite garnet-wollastonite structures formed during the first stage. The shorter mixing duration of approximately 5 minutes may prevent mechanical damage to the glass beads while ensuring adequate distribution throughout the mixture. This controlled integration may maintain the flow enhancement properties of the spherical particles while incorporating them into the reinforced matrix created by the garnet-wollastonite interaction.

The dust reduction benefits may result from the particle binding effects created by the three-component mixture. The garnet particles may provide sufficient mass and surface area to bind smaller particles together through van der Waals forces and mechanical interlocking. The wollastonite component may contribute to dust reduction through its fibrous structure that may create physical barriers to particle separation. The glass beads may enhance particle cohesion through their smooth surfaces that may promote closer packing and reduced void spaces within the mixture.

The scratch resistance enhancement may be achieved through multiple mechanisms operating simultaneously within the enhanced plaster, gypsum mud, mortar, grout and/or other cementitious compound matrix. The garnet component may provide primary resistance through its hardness characteristics that may create wear-resistant contact points throughout the surface. The wollastonite crystals may provide secondary resistance through their reinforcing fiber network that may distribute stress loads and prevent crack propagation. The glass beads may contribute to scratch resistance by providing smooth load-bearing surfaces that may deflect scratching implements away from more vulnerable matrix areas.

The humidity resistance properties may be enhanced through the moisture barrier characteristics of the wollastonite component combined with the dense packing effects of the three-component mixture. The calcium silicate structure of wollastonite may exhibit low water absorption that may prevent moisture-induced swelling and subsequent cracking. The glass beads may contribute to humidity resistance through their non-porous surfaces that may provide additional moisture barriers. The garnet component may enhance overall dimensional stability through its low thermal expansion characteristics that may minimize moisture-related dimensional changes.

The workability improvements may result from the flow enhancement properties of the glass bead component combined with the controlled particle size distribution of the complete mixture. The spherical geometry of glass beads may reduce internal friction during mixing and application, allowing for smoother tool movement and reduced application force requirements. The composite granular structure may provide optimal particle packing that may minimize void spaces while maintaining adequate lubrication for workability. The balanced component ratios may ensure that flow enhancement properties may be maintained without compromising other performance characteristics.

The chemical inertness of all three components may ensure long-term stability and compatibility with various compound formulations. The garnet component may maintain its crystalline structure and hardness characteristics throughout the service life of the applied surface. The wollastonite component may resist chemical attack in alkaline environments typically present in gypsum-based materials. The glass bead component may provide stable performance characteristics that may not degrade over time or react with other mixture components.

The sanding reduction benefits may be achieved through the improved surface finish characteristics provided by the glass bead component combined with the reinforcement effects of garnet and wollastonite. The spherical particles may create micro-smooth surfaces during application that may reduce the need for subsequent sanding operations. The reinforced matrix may maintain surface integrity during application, reducing the formation of surface defects that may otherwise require sanding correction. The combined effects may result in surfaces that may meet finish requirements with minimal post-application processing.

The manufacturing process may create unique granular structures that may not be achievable through alternative mixing methods. The tumble mixing action may provide controlled mechanical energy that may promote optimal component integration without excessive particle breakdown. The two-stage approach may allow for sequential development of composite structures that may maximize synergistic effects between components. The specific timing parameters may be optimized to achieve complete integration while preserving the beneficial characteristics of each component.
Aspect 1. A method of preparing an additive for plaster, gypsum mud, mortar, grout, and/or other cementitious compounds, the method comprising: mixing wollastonite and garnet in a tumble mixer for a first predetermined time period; adding glass beads to the mixture of wollastonite and garnet; and continuing to mix the wollastonite, garnet, and glass beads in the tumble mixer for a second predetermined time period.
Aspect 2. The method of any previous Aspect, wherein the first predetermined time period is approximately 10 minutes.
Aspect 3. The method of any previous Aspect, wherein the second predetermined time period is approximately 5 minutes.
Aspect 4. The method any previous Aspect, wherein the wollastonite and garnet are mixed in a ratio of approximately 1:2.
Aspect 5. The method of any previous Aspect, wherein the additive comprises approximately 50% garnet, 25% glass beads, and 25% wollastonite by weight.
Aspect 6. The method of any previous Aspect, further comprising packaging the mixed additive in a granular form.
Aspect 7. A method of enhancing plaster, gypsum mud, mortar, grout and/or other cementitious compounds, the method comprising: obtaining an additive prepared by mixing wollastonite, garnet, and glass beads; combining the additive with the compound; and applying the combined additive and compound to a surface.
Aspect 8. The method of any previous Aspect, wherein the additive is in a granular form.
Aspect 9. The method of any previous Aspect, wherein the additive comprises approximately 50% garnet, 25% glass beads, and 25% wollastonite by weight.
Aspect 10. The method of any previous Aspect, wherein combining the additive with the plaster, the gypsum mud, the mortar, the grout, and/or the other cementitious compounds results in a mixture with increased scratch resistance compared to compounds without the additive.

Aspect 11. The method of any previous Aspect, wherein combining the additive with the plaster, the gypsum mud, the mortar, the grout, and/or the other cementitious compounds results in a mixture with reduced dust emission compared to compounds without the additive.
Aspect 12. The method of any previous Aspect, wherein combining the additive with the plaster, the gypsum mud, the mortar, the grout, and/or the other cementitious compounds results in a mixture with reduced clumping due to humidity compared to compounds without the additive.
Aspect 13. A method of manufacturing an additive for plaster, gypsum mud, mortar, grout, and/or other cementitious compounds, the method comprising: obtaining wollastonite, garnet, and glass beads; mixing the wollastonite and garnet in a first mixing operation; adding the glass beads to the mixture of wollastonite and garnet; and performing a second mixing operation on the wollastonite, garnet, and glass beads to form a granular additive.
Aspect 14. The method of any previous Aspect, wherein the first mixing operation comprises tumble mixing the wollastonite and garnet for approximately 10 minutes.
Aspect 15. The method of any previous Aspect, wherein the second mixing operation comprises tumble mixing the wollastonite, garnet, and glass beads for approximately 5 minutes.
Aspect 16. The method of any previous Aspect, wherein the granular additive comprises approximately 50% garnet, 25% glass beads, and 25% wollastonite by weight.
Aspect 17. The method of any previous Aspect, further comprising: packaging the granular additive for distribution to end users.
Aspect 18. The method of any previous Aspect, wherein the granular additive is configured to be combined with plaster, gypsum mud, mortar, grout, and/or other cementitious compounds to enhance at least one property of the compound.
Aspect 19. The method of any previous Aspect, wherein the at least one property comprises scratch resistance, dust emission, or resistance to clumping due to humidity.
Aspect 20. The method of any previous Aspect, wherein the wollastonite, garnet, and glass beads are inert materials.
Aspect 21. A composition for use as an additive in plaster, gypsum mud, mortar, grout, and/or other cementitious compounds, the composition comprising: garnet; glass beads; and wollastonite, wherein the composition is in a granular form.
Aspect 22. The composition of any previous Aspect, wherein the composition comprises approximately 50% garnet, 25% glass beads, and 25% wollastonite by weight.
Aspect 23. The composition of any previous Aspect, wherein the composition is configured to increase scratch resistance when combined with plaster, gypsum mud, mortar, grout and/or other cementitious compounds.
Aspect 24. The composition of any previous Aspect, wherein the composition is configured to reduce dust emission when combined with plaster, gypsum mud, mortar, grout and/or other cementitious compounds.
Aspect 25. The composition of any previous Aspect, wherein the composition is configured to reduce clumping due to humidity when combined with plaster, gypsum mud, mortar, grout and/or other cementitious compounds.
Aspect 26. The composition of any previous Aspect, wherein the garnet, glass beads, and wollastonite are mixed in a tumble mixer.
Aspect 27. The composition of any previous Aspect, wherein the composition is configured to be combined with plaster, gypsum mud, mortar, grout and/or other cementitious compounds without altering a set time of the compound.
Aspect 28. The composition of any previous Aspect, wherein the composition is inert.
Aspect 29. The composition of any previous Aspect, wherein the composition is configured to be added to plaster, gypsum mud, mortar, grout and/or other cementitious compounds in varying amounts to achieve different levels of enhancement.
Aspect 30. The composition of any previous Aspect, wherein the garnet, the glass beads, and the wollastonite are mixed in a specific ratio to achieve desired properties when combined with plaster, gypsum mud, mortar, grout and/or other cementitious compounds.
Aspect 31. A composition for use as an additive in plaster, gypsum mud, mortar, grout and/or other cementitious compounds, the composition consisting essentially of: 50% garnet, 25% glass beads, and 25% wollastonite by weight, wherein the composition is in a granular form.
Aspect 32. A composition for use as an additive in plaster, gypsum mud, mortar, grout and/or other cementitious compounds, the composition produced by a process comprising: mixing wollastonite and garnet in a tumble mixer for a first predetermined time period; adding glass beads to the mixture of wollastonite and garnet; and continuing to mix the wollastonite, garnet, and glass beads in the tumble mixer for a second predetermined time period, wherein the composition is in a granular form.
Aspect 33. The composition of any previous Aspect, wherein the first predetermined time period is approximately 10 minutes.
Aspect 34. The composition of any previous Aspect, wherein the second predetermined time period is approximately 5 minutes.
Aspect 35. The composition of any previous Aspect, wherein the wollastonite and garnet are mixed in a ratio of approximately 1:2.
Aspect 36. The composition of any previous Aspect, wherein the composition comprises approximately 50% garnet, 25% glass beads, and 25% wollastonite by weight.
Aspect 37. The composition of any previous Aspect, wherein the process further comprises packaging the composition in the granular form.
Aspect 38. The composition of any previous Aspect, wherein the composition is configured to increase scratch resistance when combined with plaster, gypsum mud, mortar, grout and/or other cementitious compounds.
Aspect 39. The composition of any previous Aspect, wherein the composition is configured to reduce dust emission when combined with plaster, gypsum mud, mortar, grout and/or other cementitious compounds.
Aspect 40. The composition of any previous Aspect, wherein the composition is configured to reduce clumping due to humidity when combined with plaster, gypsum mud, mortar, grout and/or other cementitious compounds.
Aspect 41. The composition of any previous Aspect, wherein the composition is configured to be combined with plaster, gypsum mud, mortar, grout and/or other cementitious compounds without altering a set time of the compound.
Aspect 42. the composition of any previous aspect, wherein the composition is inert.
Aspect 43. The composition of any previous Aspect, wherein the composition is configured to be added to plaster, gypsum mud, mortar, grout and/or other cementitious compounds in varying amounts to achieve different levels of enhancement.
Aspect 44.. A method of preparing an additive for plaster or gypsum mud, the method comprising: mixing wollastonite and garnet in a tumble mixer for a first predetermined time period; adding glass beads to the mixture of wollastonite and garnet; and continuing to mix the wollastonite, garnet, and glass beads in the tumble mixer for a second predetermined time period.
Aspect 45. The method of any previous Aspect, wherein the first predetermined time period is approximately 10 minutes.
Aspect 46. The method of any previous Aspect, wherein the second predetermined time period is approximately 5 minutes.
Aspect 47. The method of any previous Aspect, wherein the wollastonite and garnet are mixed in a ratio of approximately 1:2.
Aspect 48. The method of any previous Aspect, wherein the additive comprises approximately 50% garnet, 25% glass beads, and 25% wollastonite by weight.
Aspect 49. The method of any previous Aspect, further comprising: packaging the mixed additive in a granular form.
Aspect 50. A method of enhancing plaster, gypsum mud, mortar, grout and/or other cementitious compounds, the method comprising: obtaining an additive prepared by mixing wollastonite, garnet, and glass beads; combining the additive with the plaster, the gypsum mud, the mortar, the grout and/or the other cementitious compounds; and applying the combined additive and compound to a surface.
Aspect 51. The method of any previous Aspect, wherein the additive is in a granular form.
Aspect 52. The method of any previous Aspect, wherein the additive comprises approximately 50% garnet, 25% glass beads, and 25% wollastonite by weight.
Aspect 53. The method of any previous Aspect, wherein combining the additive with the plaster, the gypsum mud, the mortar, the grout, and/or the other cementitious compounds results in a mixture with increased scratch resistance compared to compounds without the additive.
Aspect 54. The method of any previous Aspect, wherein combining the additive with the plaster, the gypsum mud, the mortar, the grout, and/or the other cementitious compounds results in a mixture with reduced dust emission compared to compounds without the additive.
Aspect 55. The method of any previous Aspect, wherein combining the additive with the plaster, the gypsum mud, the mortar, the grout, and/or the other cementitious compounds results in a mixture with reduced clumping due to humidity compared to compounds without the additive.
Aspect 56. A composition for use as an additive in plaster, gypsum mud, mortar, grout, and/or other cementitious compounds, the composition consisting essentially of: 50% garnet, 25% glass beads, and 25% wollastonite by weight, wherein the composition is in a granular form.
Aspect 57. The composition of any previous Aspect, wherein the composition is configured to increase scratch resistance when combined with the plaster, the gypsum mud, the mortar, the grout, and/or the other cementitious compounds.
Aspect 58. The composition of any previous Aspect, wherein the composition is configured to reduce dust emission when combined with the plaster, the gypsum mud, the mortar, the grout, and/or the other cementitious compounds.
Aspect 59. The composition of any previous Aspect, wherein the composition is configured to reduce clumping due to humidity when combined with the plaster, the gypsum mud, the mortar, the grout, and/or the other cementitious compounds.
Aspect 60.. The composition of any previous Aspect, wherein the composition is configured to be combined with the plaster, the gypsum mud, the mortar, the grout, and/or the other cementitious compounds without altering a set time of the compounds.
Aspect 61. The composition of any previous Aspect, wherein the composition is configured to be added to the plaster, the gypsum mud, the mortar, the grout, and/or the other cementitious compounds in varying amounts to achieve different levels of enhancement.
Aspect 62. The composition of any previous Aspect, wherein the glass beads comprise spherical particles having a diameter in the range of about 10 micrometers to about 1000 micrometers.
Aspect 63. The composition of any previous Aspect, wherein the composition is produced by a process comprising: mixing the wollastonite and garnet in a tumble mixer for a first predetermined time period; adding the glass beads to the mixture of wollastonite and garnet; and continuing to mix the wollastonite, garnet, and glass beads in the tumble mixer for a second predetermined time period.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as examples for embodiments of the disclosure.

Insofar as the description above and the accompanying drawing disclose any additional subject matter that is not within the scope of the claims below, the disclosures are not dedicated to the public and the right to file one or more applications to claims such additional disclosures is reserved.

1. A method of preparing an additive for plaster, gypsum mud, mortar, grout, and/or other cementitious compounds, the method comprising:
mixing wollastonite and garnet in a tumble mixer for a first predetermined time period;
adding glass beads to the mixture of wollastonite and garnet; and
continuing to mix the wollastonite, garnet, and glass beads in the tumble mixer for a second predetermined time period.

2. The method of claim 1, wherein the first predetermined time period is approximately 10 minutes.

3. The method of claim 1, wherein the second predetermined time period is approximately 5 minutes.

4. The method of claim 1, wherein the wollastonite and garnet are mixed in a ratio of approximately 1:2.

5. The method of claim 1, wherein the additive comprises approximately 50% garnet, 25% glass beads, and 25% wollastonite by weight.

6. The method of claim 1, further comprising:
packaging the mixed additive in a granular form.

7. A method of enhancing plaster, gypsum mud, mortar, grout, and/or other cementitious compounds, the method comprising:
obtaining an additive prepared by mixing wollastonite, garnet, and glass beads;
combining the additive with the compound; and
applying the combined additive and compound to a surface.

8. The method of claim 7, wherein the additive is in a granular form.

9. The method of claim 7, wherein the additive comprises approximately 50% garnet, 25% glass beads, and 25% wollastonite by weight.

10. The method of claim 7, wherein combining the additive with the compound results in a mixture with increased scratch resistance compared to compounds without the additive.

11. The method of claim 7, wherein combining the additive with the compound results in a mixture with reduced dust emission compared to compounds without the additive.

12. The method of claim 7, wherein combining the additive with the compound results in a mixture with reduced clumping due to humidity compared to compounds without the additive.

13. A composition for use as an additive in plaster, gypsum mud, mortar, grout, and/or other cementitious compounds, the composition consisting essentially of:
50% garnet, 25% glass beads, and 25% wollastonite by weight,
wherein the composition is in a granular form.

14. The composition of claim 13, wherein the composition is configured to increase scratch resistance when combined with plaster, gypsum mud, mortar, grout, and/or other cementitious compounds.

15. The composition of claim 13, wherein the composition is configured to reduce dust emission when combined with plaster, gypsum mud, mortar, grout, and/or other cementitious compounds.

16. The composition of claim 13, wherein the composition is configured to reduce clumping due to humidity when combined with plaster, gypsum mud, mortar, grout, and/or other cementitious compounds.

17. The composition of claim 13, wherein the composition is configured to be combined with plaster, gypsum mud, mortar, grout, and/or other cementitious compounds without altering a set time of the compound.

18. The composition of claim 13, wherein the composition is configured to be added to plaster, gypsum mud, mortar, grout, and/or other cementitious compounds in varying amounts to achieve different levels of enhancement.

19. The composition of claim 13, wherein the glass beads comprise spherical particles having a diameter in the range of about 10 micrometers to about 1000 micrometers.

20. The composition of claim 13, wherein the composition is produced by a process comprising:
mixing the wollastonite and garnet in a tumble mixer for a first predetermined time period;
adding the glass beads to the mixture of wollastonite and garnet; and
continuing to mix the wollastonite, garnet, and glass beads in the tumble mixer for a second predetermined time period.
